(19) United States
(12) Patent Application Publication
(10) Pub. No.: US 2012/0068895 A1
(43) Pub. Date: Mar. 22, 2012

(54) PORTABLE WIRELESS DEVICE

(75) Inventor: Takeshi Yamaguchi, Kanagawa (JP)

(73) Assignee: PANASONIC CORPORATION, Osaka (JP)

(21) Appl. No.: 13/320,159

(22) PCT Filed: Mar. 3, 2010
(86) PCT No.: PCT/JP2010/001478

§ 371 Date: Nov. 11, 2011

(30) Foreign Application Priority Data
May 13, 2009 (JP) 2009-116623

(51) Int. Cl. H01Q 1/24

(52) U.S. Cl. 343/702

(57) ABSTRACT

A portable wireless device includes: a first housing including therein an antenna element and a circuit board disposed in parallel therewith; a second housing disposed to overlap with the first housing; and a tilt holding member including a hinge part which rotatably connects one end side of the first housing and one end side of the second housing to each other and which is configured to hold the second housing in a state in which the second housing is tilted with respect to the first housing. The tilt holding member includes a cored bar made of a metal material disposed along an arrangement direction of the circuit board and the antenna element. The cored bar is divided outside an arrangement range of the circuit board at the antenna element side in the arrangement direction.

### TECHNICAL FIELD

The present invention relates to a portable wireless device.

### BACKGROUND ART

In recent years, with the wide popularization of portable wireless devices such as cellular phones, the user requires products low in size and weight and excellent in design have been. Taking the user-friendliness and design into consideration, there have been widely provided various portable wireless devices such as a folding portable wireless device in which a pair of upper and lower housings are connected by hinge (for example, refer to Patent Document 1), or a slidable portable wireless device in which along a surface of a display part on one housing, the other housing is slidable (for example, refer to Patent Document 2). Also, in recent years, there is a portable wireless device having a tilt-up mechanism in which one housing with a display part is held to be tilted up with respect to the other housing.

### RELATED ART DOCUMENTS

### Patent Documents

Patent Document 1: JP-A-2007-158718
Patent Document 2: JP-A-2006-203806

### SUMMARY OF THE INVENTION

### Problem to be Solved by the Invention

In the above-mentioned portable wireless devices, an installation space of parts within the housings are constrained, and an antenna element and other metal parts are located close to each other. In particular, in the portable wireless device having the tilt-up mechanism, the constraint of the installation spaces becomes stricter, unavoidably resulting in an arrangement in which the antenna element is extremely close to the metal parts. In the tilt-up mechanism, there exists a tilt holding member made of metal in which one housing having the display part is held to the other housing, and the tilt holding member is disposed close to the antenna element. Then, the antenna element is affected by a ground, and radiation resistance is decreased to deteriorate antenna characteristics. Under the circumstances, it is conceivable that the tilt holding member is made of a resin material to prevent the antenna characteristic from being deteriorated. However, in this case, strength of the tilt-up mechanism cannot be ensured.

The present invention has been made in view of the above circumstances, and aims at providing a portable wireless device that can always obtain excellent antenna characteristics with a reduction in the deterioration of the antenna characteristics by avoiding an influence of the ground from a circuit board disposed close to an antenna element while maintaining the strength of the tilt-up mechanism.

### Means for Solving the Problem

According to the present invention, there is provided a portable wireless device including: a first housing including therein an antenna element and a circuit board disposed in parallel therewith; a second housing disposed to overlap with the first housing; and a tilt holding member including a hinge part which rotatably connects one end side of the first housing and one end side of the second housing to each other and which is configured to hold the second housing in a state in which the second housing is tilted with respect to the first housing, wherein the tilt holding member includes a cored bar made of a metal material disposed along an arrangement direction of the circuit board and the antenna element, and wherein the cored bar is divided outside an arrangement range of the circuit board at the antenna element side in the arrangement direction.

With the above configuration, the excellent antenna characteristics can be always obtained with a reduction in the deterioration of the antenna characteristics by avoiding an influence of the ground from the circuit board disposed close to the antenna element while maintaining the strength of the tilt-up mechanism.

Also, according to the present invention, there is provided the portable wireless device including: a slide rail arranged on a side of the second housing facing the first housing along a direction orthogonal to the arrangement direction; and a slider arranged at a side of the tilt holding member facing the second housing, and slidably engaged with the slide rail, wherein the second housing can be tilted with respect to the first housing by sliding the second housing along the slide rail with respect to the first housing and then rotating the hinge part at a termination position of the slider.

With the above configuration, even in a structure where the first and second housings mutually slide in which the arrangement space of the parts is largely restricted, the excellent antenna characteristics can be obtained.

Also, according to the present invention, there is provided the portable wireless device in which the second housing includes a front surface side housing and an intermediate housing disposed between the front surface side housing and the first housing, and in which the intermediate housing is connected to the hinge part of the tilt holding member, and is connected to the front surface side housing so as to be slidable along the arrangement direction.

With the above configuration, even in a structure where the intermediate housing is provided in which the arrangement space of the parts is further restricted, the excellent antenna characteristics can be obtained.

Also, according to the present invention, there is provided the portable wireless device in which the arrangement range of the circuit board is a formation range of a ground pattern.

With the above configuration, the cored bar is divided outside the formation range of the ground pattern, whereby a selection range of the division position is extended to a maximum extent to improve the degree of freedom of design.

According to the present invention, there is provided the portable wireless device in which the cored bar is divided at a position outside the arrangement range of the antenna element in the arrangement direction.

With the above configuration, the deterioration of the antenna characteristics caused by coupling a base end of the cored bar opposite to the antenna element to the antenna element can be prevented.

According to the present invention, there is provided the portable wireless device in which the tilt holding member includes an insert molding product in which the metal material of the cored bar is integrally molded with a resin material.

With the above configuration, even if the cored bar is divided, the strength of the tilt holding member can be ensured by the resin material.

According to the present invention, there is provided the portable wireless device in which each of the first housing and the second housing is substantially a cuboid, and the arrangement direction is a long side direction of the cuboid.

With the above configuration, the housings of substantially cuboids are excellent in usability such as the gripping property and operability, and also excellent aesthetically.

### Advantages of the Invention

According to the present invention, the excellent antenna characteristics can be always obtained with a reduction in the deterioration of the antenna characteristics by avoiding an influence of the ground from the circuit board disposed close to the antenna element while maintaining the strength of the tilt-up mechanism.

### BRIEF DESCRIPTION OF THE DRAWINGS

FIG. 1 is a schematic perspective view illustrating a tilt-up state of one configuration example of a portable wireless device.

FIG. 2 is a plan view of a slide state of the portable wireless device illustrated in FIG. 1.

FIG. 3 is a view taken along an arrow A-A of the portable wireless device illustrated in FIG. 3.

FIG. 4 is a plan view of a tilt holding member.

FIG. 5 is a conceptual side view of a short side of the portable wireless device illustrated in FIG. 1 viewed laterally.

FIGS. 6(A) to 6(C) are side views of the short side of the portable wireless device, in which FIGS. 6(A), 6(B), and 6(C) are operation illustrative schematic diagrams illustrating a closed state, a slide state, and a tilt-up state, respectively.

FIG. 7 is an enlarged plan view illustrating one configuration example of an arrangement side of an antenna element in a first housing illustrated in FIG. 2.

FIGS. 8A and 8B are schematic plan views illustrating a division position of a cored bar of the tilt holding member and antenna characteristics in which FIG. 8(A) is an illustrative diagram illustrating a case in which the cored bar is divided within an arrangement range of the circuit board, and FIG. 8(B) is an illustrative diagram illustrating a case in which the cored bar is divided within an arrangement range of the antenna element.

FIGS. 9(A) and 9(B) are diagrams illustrating an configuration example in which the second housing has an intermediate housing between the second housing and the first housing, in which FIGS. 9(A), 9(B), and 9(C) are illustrative schematic diagrams illustrating a front view of a closed state, a front view of a slide state, and a side view of a tilt-up state, respectively.

### MODE FOR CARRYING OUT THE INVENTION

In the following embodiments, a description will be given of configuration examples of a portable wireless device when the present invention is applied to a portable terminal device such as a cellular phone. The present invention is applicable to various portable wireless devices that can be carried by users.

First, a description will be given of the configuration of the portable wireless device that can hold a state in which after a pair of upper and lower housings overlap with each other, and then slide in parallel (hereinafter referred to as “slide state”), one housing is tilted up at a given angle with respect to the other housing (hereinafter referred to as “tilt-up state”).

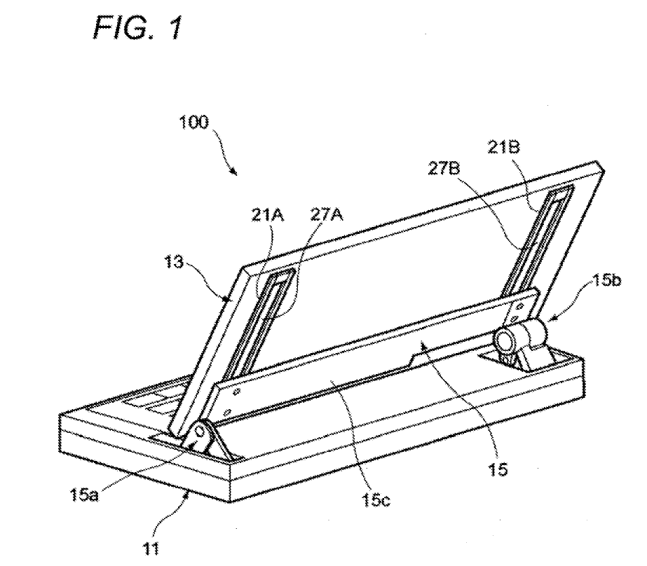

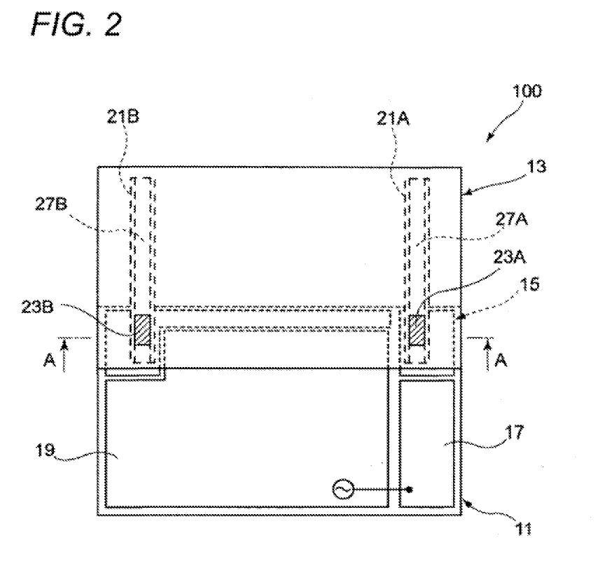

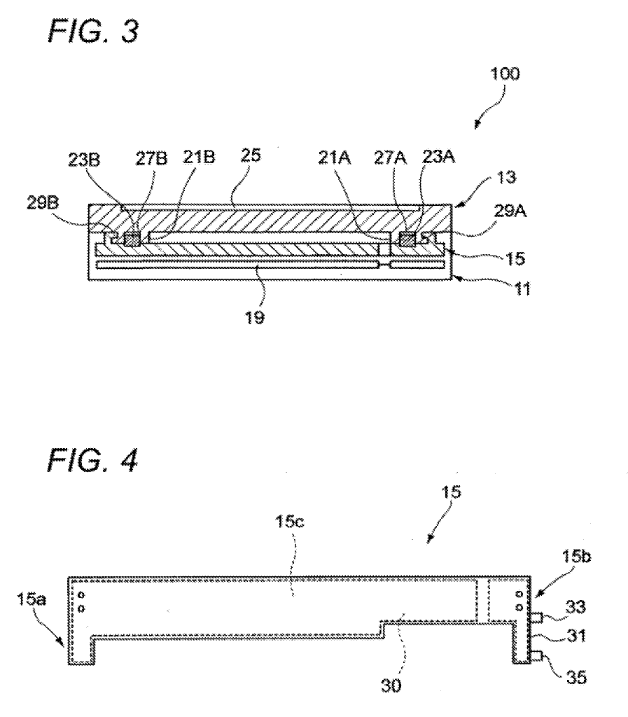

FIG. 1 is a schematic perspective view illustrating one configuration example of a portable wireless device, which illustrates the tilt-up state. Also, FIG. 2 is a plan view of a slide state of the portable wireless device illustrated in FIG. 1, and FIG. 3 is a view taken along an arrow A-A of the portable wireless device illustrated in FIG. 3.

A portable wireless device 100 illustrated in FIG. 1 mainly includes a first housing 11, a second housing 13, and a tilt holding member 15, and the second housing 13 is slidably supported by the tilt holding member 15. Also, the tilt holding member 15 is rotatably supported by the first housing 11 through hinge parts 15a and 15b, and the second housing 13 is tiltably held by the first housing 11.

The first housing 11 is substantially a cuboid that is rectangular in a planar view as illustrated in FIG. 2, and an antenna element 17 and a circuit board 19 are disposed in parallel within the housing. Also, the tilt holding member 15 is disposed at one side of the antenna element 17 and the circuit board 19 along an arrangement direction thereof.

The second housing 13 is substantially a cuboid that is rectangular in a planar view, with substantially the same size as that of the first housing 11, and has guide rails 21A and 218 at both ends thereof in a longitudinal direction (lateral direction in FIG. 2). As illustrated in FIGS. 2 and 3, the guide rails 21A and 218 are slidably engaged with sliders 23A and 23B disposed on a side of the tilt holding member 15 facing the second housing 13 so that the second housing 13 is slidable with respect to the first housing 11. The guide rails 21A and 21B may be configured by attachment of rail members onto an outer surface of the second housing 13, or provision of rail-shaped protrusions formed by a concavo-convex pattern on the outer surface of the second housing 13.

That is, as illustrated in FIGS. 1 to 3, the guide rails 21A and 21B have grooves 27A and 278 formed of a pair of protrusions that are arranged along a short side (along a vertical direction of FIG. 2) of the rectangle of the second housing 13 in the planar view, and arranged at a given distance. The sliders 23A and 23B of the tilt holding member 15 are engaged with the grooves 27A and 27B so as to be slidable along the short side of the rectangle of the second housing in the planar view. In the tilt holding member 15, as illustrated in FIG. 3, engagement claws 29A and 29B for retaining the sliders 23A and 238 in the guide rails 21A and 21B are formed outside the sliders 23A and 23B. With the above configuration, the guide rails 21A and 21B guide the sliding operation of the second housing with respect to the first housing 11.

Also, as illustrated in FIG. 3, a display part 25 is disposed on a front surface of the second housing 13 opposite to the first housing 11 side. The display part 25 is, for example, a liquid crystal display device, and displays information such as an image of image data received by the antenna element 17, and, for example, enables looking and listening of a digital television broadcast. As described above, since the first housing 11 and the second housing 13 are substantially cuboid, the configuration can be made excellent in usability such as the gripping property and operability, and also excellent aesthetically.

FIG. 4 illustrates a plan view of the tilt holding member. In the following description, the same components as the members illustrated in FIGS. 1 to 3 are denoted by identical reference symbols, and their description will be simplified or omitted.

The tilt holding member 15 includes the hinge parts 15a and 15b made of a metal material, and a plate part 15c that connects the hinge parts 15a and 15b to each other. The tilt holding member 15 is formed of an insert molding product in which a cored bar 30 made of a metal material such as an iron sheet is integrally molded with a resin material in the plate part 15c, and the hinge parts 15a and 15b are also integrally molded therewith. The hinge parts 15a and 15b of the tilt holding member 15 is fitted to the first housing 11, and the first housing 11 and the second housing 13 are rotatably connected to each other.

Subsequently, a description will be given of the configuration of the hinge parts 15a and 15b of the tilt holding member 15 as well as the rotating operation of the first housing 11 and the second housing 13.

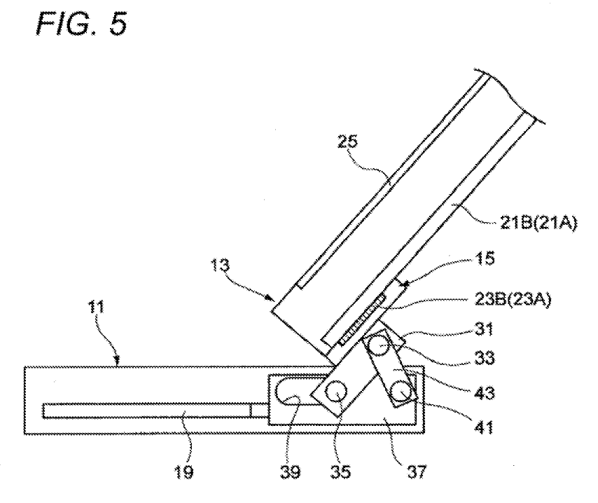

FIG. 5 is a conceptual side view of the short side of the portable wireless device illustrated in FIG. 1 viewed laterally.

The tilt holding member 15 includes the hinge parts 15a and 15b at both sides thereof, and each of the hinge parts 15a and 16b is integrally connected to a first arm 31. The first arm 31 includes a first shaft 33 that is a rotating shaft, and a second shaft 35 formed at a leading end of the first arm 31. The second shaft 35 is inserted into a horizontal elongate hole 39 of a support plate 37 fixed to the first housing 11, and supported movably in a longitudinal direction of the horizontal elongate hole 39. Also, the first shaft 33, the second shaft 35, and a third shaft 41 are arranged in parallel to each other.

Subsequently, a description will be given of the operation of sliding and tilting up the second housing 13 with respect to the first housing 11 with the above configuration of the guide rails 21A, 21B, and the hinge parts 15a, 15b.

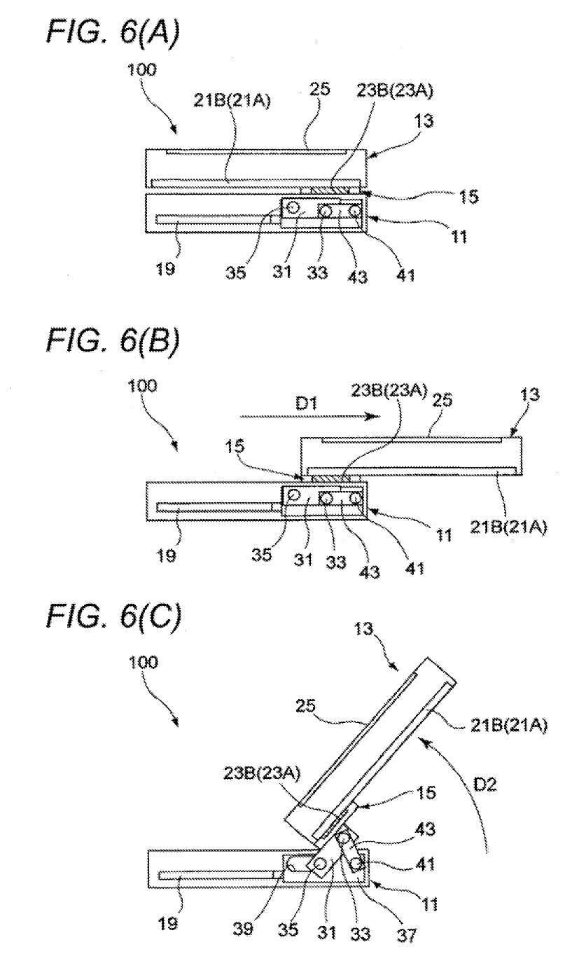

FIG. 6 is side views of the short side of the portable wireless device, in which FIGS. 6(A), 6(B), and 6(C) are operation illustrative schematic diagrams illustrating a closed state, a slide state, and a tilt-up state, respectively.

In the closed state illustrated in FIG. 6(A), the portable wireless device 100 slides the second housing 13 with respect to the first housing 11 in a short side direction (direction indicated by an arrow D1) as illustrated in FIG. 6(B). In this situation, the second housing 13 slides with respect to the first housing 11 while the sliders 23A and 238 are guided by the guide rails 21A and 21B. As a result, the portable wireless device 100 comes into the slide state from the closed state.

Then, in the slide state where the second housing 13 moves to slide terminated positions of the guide rails 21A and 21B, the second housing 13 is tilted up with respect to the first housing 11. That is, in a state where the second housing 13 is connected to the first housing 11 through the tilt holding member 15, the second housing 13 rotates in a rising direction (direction indicated by an arrow D2) with respective to the first housing 11. Then, the tilt holding member 15 is held in the tilt-up state where the second housing 13 rises at a given angle with respect to the first housing 11 by the hinge parts 15a and 15b (refer to FIG. 1) of the tilt holding member 15. As a result, the portable wireless device 100 comes into an open state.

In the tilt holding member 15 when conducting the tilt-up operation, a second arm 43 rotates clockwise in FIG. 6(C) with the third shaft 41 as a fulcrum, and the first arm 31 rotates counterclockwise in FIG. 6(C) with the first shaft 33 as a fulcrum. With this operation, the second shaft 35 slides in the horizontal elongate hole 39 toward the third shaft 41 (slide in a right direction of FIG. 6(C)). As a result, in the tilt holding member 15, a part of each of the second arm 43 and the first arm 31 projects from the first housing 11 toward the external, and is tilted with respect to the first housing 11.

When the portable wireless device 100 comes into the open state illustrated in FIG. 6(C), the portable wireless device 100 can display an image of the digital television broadcast on the display part 25 disposed in the second housing 13 with high visibility when receiving radio waves of the digital television broadcast.

In termination of the looking and listening of the digital television broadcast, the second housing 13 rotates in a lying direction with respect to the first housing 11 from the open state of the portable wireless device 100 in the state where the second housing 13 is connected to the first housing 11 through the tilt holding member 15. As a result, the portable wireless device 100 returns to the slide state before the tilt-up operation.

In this situation, in the tilt holding member 15, the second arm 43 rotates counterclockwise in FIG. 6(C) with the third shaft 41 as the fulcrum, and the first arm 31 rotates clockwise in FIG. 6(C) with the first shaft 33 as the fulcrum. With this rotation, the second shaft 35 slides in the horizontal elongate hole 39 in a left direction of FIG. 6(C). As a result, the overall tilt holding member 15 is housed within the first housing 11.

Subsequently, a description will be given in detail of a layout relationship of the tilt holding member 15, the antenna element 17, and the circuit board 19 illustrated in FIG. 2 in the portable wireless device 100 that enables the slide operation and the tilt-up operation as described above.

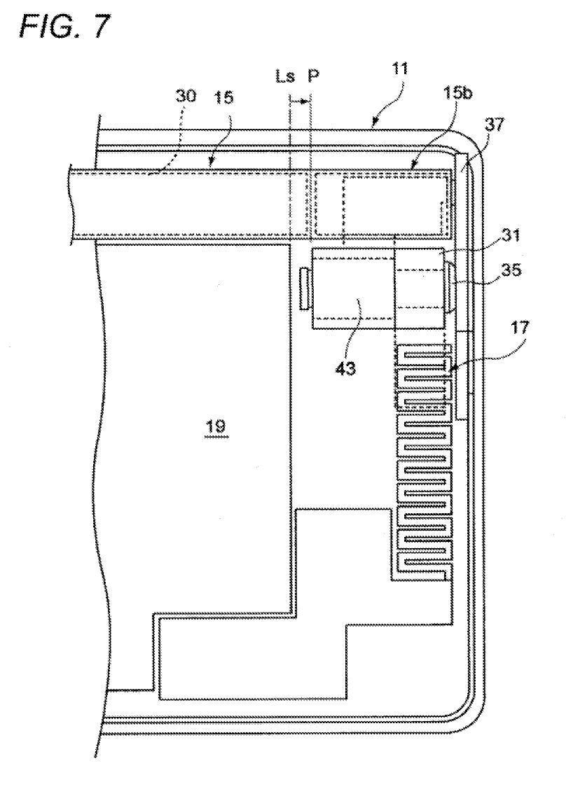

FIG. 7 is an enlarged plan view illustrating one configuration example of an arrangement side of the antenna element 17 in the first housing 11 illustrated in FIG. 2. The configuration example illustrated in FIG. 7 is exemplary, and the present invention is not limited to this configuration.

The tilt holding member 15, the antenna element 17, and the circuit board 19 are arranged at one short side of the first housing 11 so as to be close to each other. That is, the antenna element 17 and the circuit board 19 are disposed in parallel along a longitudinal direction of the first housing 11, and the tilt holding member 15 is disposed at a side of the circuit board 19 along an arrangement direction of the antenna element 17 and the circuit board 19. The tilt holding member 15 is disposed at a position close to the circuit board 19 along one long side of the circuit board 19 of a substantially rectangle, and the antenna element 17 is disposed at a position close to a short side of the circuit board 19. In particular, an end of the meander antenna element 17 extends to a position extremely close to the first arm 31 configuring the hinge part 15b of the tilt holding member 15, and the antenna element 17 and a metal portion of the tilt holding member 15 are capacitively coupled to each other.

Because the capacitive coupling of the antenna element 17 and the tilt holding member 15 deteriorates the antenna characteristic, in the tilt holding member 15 according to this embodiment, the hinge part 15b (ditto with 15a) that is a joint part between the members and needs a high strength is made of a metal material, and the cored bar 30 is divided in the plate part 15c located between the hinge parts 15a and 15b where a stress is relatively hardly concentrated. It is assumed that a division position of the cored bar 30 is a position P that extends from a line Ls extending from the short side of the circuit board 19 illustrated in FIG. 7 toward a direction away from the circuit board 19. That is, at the antenna element 17 side in the arrangement direction of the antenna element 17 and the circuit board 19 within the first housing 11, the cored bar 30 is divided outside an arrangement range of the circuit board 19 in the arrangement direction.

With the above configuration, even if the antenna element 17 is capacitively coupled to the first arm 31 of the tilt holding member 15, the hinge part 15b connected to the first arm 31 is electrically disconnected to the cored bar 30 divided at the circuit board 19 side at the position away from the arrangement range of the circuit board 19. Therefore, the antenna element 17 is not coupled to the ground caused by the circuit board 19, thereby not leading to the deterioration of the antenna characteristics.

Also, since the cored bar 30 of the tilt holding member 15 is divided at the position of the plate part 15c disposed between the hinge parts 15a and 15b, which does not particularly need a high strength, the required strength of the tilt holding member 15 as a whole can be maintained.

The arrangement range of the circuit board 19 may be strictly a formation range of a ground pattern formed in the circuit board 19. Because the ground pattern is generally frequently arranged up to an outer edge of the circuit board 19, the arrangement range of the circuit board 19 almost corresponds to the formation range of the ground pattern. However, when the ground pattern is formed in a part of the circuit board 19, the division position of the cored bar 30 in the tilt holding member 15 can be set within a range of the circuit board 19 except for the formation range of the ground pattern. In this case, a selection range of the division position of the cored bar 30 is extended to a maximum extent to improve the degree of freedom of design.

Subsequently, the division position of the cored bar 30 will be described in more detail.

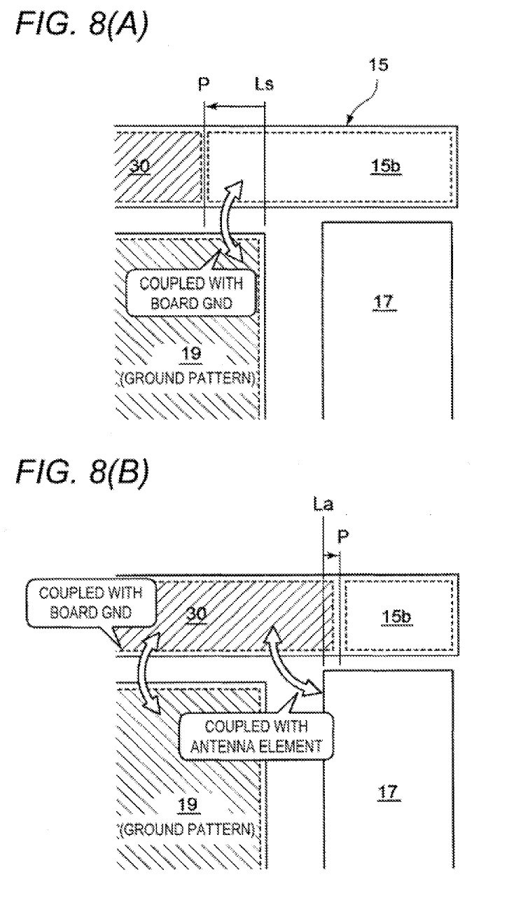

FIG. 8 is schematic plan view illustrating the division position of the cored bar of the tilt holding member and the antenna characteristic, in which FIG. 8(A) is an illustrative diagram illustrating a case in which the cored bar is divided within the arrangement range of the circuit board, and FIG. 8(B) is an illustrative diagram illustrating a case in which the cored bar is divided within the arrangement range of the antenna element.

As illustrated in FIG. 8(A), when the division position P of the cored bar 30 is at the arrangement range side of the circuit board 19, that is, at a side from the line Ls extending from the short side of the circuit board 19 along the long side of the circuit board 19, the metal portion extending from the hinge part 15b toward the cored bar 30 is coupled to the ground caused by the circuit board 19. Because the tilt holding member 15 is capacitively coupled to the antenna element 17, the antenna element 17 is affected by the ground caused by the circuit board 19 through the hinge part 15b to deteriorate the antenna characteristics.

On the other hand, as illustrated in FIG. 8(B), the division position of the cored bar 30 is at the arrangement range side of the antenna element 17, that is, at a side from the line Ls extending from the side of the circuit board 19 of the antenna element 17 along the antenna element 17, a leading end of the cored bar 30 extending toward the hinge part 15b comes close to the antenna element 17, and the cored bar 30 is capacitively coupled to the antenna element 17. Because the cored bar 30 is arranged at a close range of the circuit board 19, the cored bar 30 is liable to be coupled with the ground caused by the circuit board 19 with the results that the antenna element 17 is affected by the board ground to deteriorate the antenna characteristics.

From the above viewpoint, it is desirable that the division position of the cored bar 30 of the tilt holding member 15 is outside the arrangement range of the circuit board 19 at the antenna element side in the arrangement direction of the antenna element 17 and the circuit board 19, and outside the arrangement range of the antenna element 17 in the arrangement direction.

With the above configuration, the excellent antenna characteristics can be always obtained with a reduction in the deterioration of the antenna characteristics by avoiding an influence of the ground from the circuit board 19 disposed close to the antenna element 17 while maintaining the strength of the tilt-up mechanism. Also, even in a structure where the first housing 11 and the second housing 13 mutually slide in which the arrangement space of the parts is largely restricted, the excellent antenna characteristics can be obtained.

In general, in order to avoid the capacitive coupling with the antenna element 17, it is perceivable, for example, that the antenna element 17 per se is reduced to obtain an away distance of the antenna element 17 from the hinge part 15b of the tilt holding member 15. However, as a result, a reduction in the antenna volume leads to the deterioration of the antenna characteristics. Conversely, when the antenna element 17 is extended to improve the antenna characteristics, the antenna element 17 comes close to other metal portions including the tilt holding member 15, resulting in the deterioration of the antenna characteristics. According to the configuration of this embodiment, without relying on the above general solution, the antenna performance can be improved while keeping the high-density parts housing configuration by using the cored bar 30 of the tilt holding member 15. Moreover, the strength of the tilt-up mechanism can be ensured.

Also, in the arrangement relationship of the antenna element 17 and the circuit board 19, the antenna element 17 is arranged at the right side of the circuit board 19 illustrated in FIG. 2, or the antenna element 17 is arranged at the left side of the circuit board 19. Even in this case, it is only necessary that the cored bar 30 of the tilt holding member 15 is divided at the side where the antenna element 17 is arranged, and the present invention is applicable to any arrangements.

Subsequently, a modified example of the portable wireless device according to this embodiment will be described.

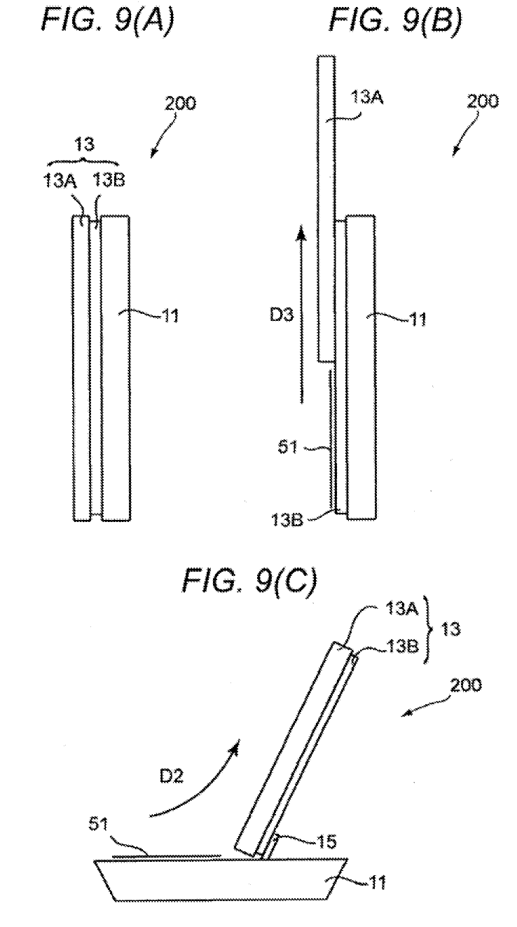

FIG. 9 is diagrams illustrating an configuration example in which the second housing has an intermediate housing between the second housing and the first housing, in which FIGS. 9(A), 9(B), and 9(C) are illustrative schematic diagrams illustrating a front view of a closed state, a front view of a slide state, and a side view of a tilt-up state, respectively.

As illustrated in FIG. 9(A), a portable wireless device 200 is identical with the configuration of the above portable wireless device 100 except that the second housing 13 is made up of a front surface side housing 13A and an intermediate housing 13B. In this configuration example, guide rails and sliders are arranged between the front surface side housing 13A and the intermediate housing 13B in the same manner as described above although not shown, and the front surface side housing 13A is slidable in a direction D3 as illustrated in FIG. 9(B). In this case, the direction D3 is orthogonal to an extension direction (direction D6) of the guide rails 21A and 21B illustrated in FIGS. 2 and 6. The guide rails for sliding in the direction D3 are arranged along the long side of the second housing 13 of the rectangle in the front view. On a front surface of the intermediate housing 13B exposed by sliding the front surface side housing 13A is arranged a key operation part 51 formed of a flexible printed circuit board.

Also, as illustrated in FIG. 9(C), with the above tilt-up mechanism including the tilt holding member 15, the second housing 13 is tilted up with respect to the first housing 11. On a front surface of the first housing 11 exposed by this tilt-up is arranged the key operation part 51 formed of a flexible printed circuit board.

In this multilayer structure, particularly, the arrangement space of the housed parts is largely restricted, and the tilt holding member, the antenna element, and the circuit board including the ground pattern are arranged closer to each other. In this case, the cored bar of the tilt holding member is divided outside the arrangement range of the circuit board in the arrangement direction of the antenna element and the circuit board, as a result of which the deterioration of the antenna characteristics can be reduced while keeping the strength of the tilt-up mechanism.

In the portable wireless devices 100 and 200 according to the respective embodiments as described above, the shape and the manufacturing method of the tilt holding member 15 are not limited to the illustrative examples. For example, the hinge parts 15a and 15b of the tilt holding member 15 may be separated from the plate part 15c, and fastened to the tilt holding member 15 by the aid of a metal screw. Also, the entire tilt holding member 15 is made of a metal, and the division parts are joined together by an insulating resin for integration. Thus, various configurations can be applied.

As described above, the present invention is not limited to the above embodiments, and modifications and applications by an ordinary skilled person on the basis of the disclosure of the present specification and known techniques are also intended by the present invention, and included in a scope to be protected. Also, the respective components in the above embodiments may be arbitrarily combined together without departing from the subject matter of the present invention.

The present invention is based on Japanese Patent Application No. 2009-116623 filed on May 13, 2009, and content thereof is incorporated herein by reference.

### INDUSTRIAL APPLICABILITY

According to the present invention, the excellent antenna characteristics can be always obtained with a reduction in the deterioration of the antenna characteristics by avoiding an influence of the ground from the circuit board disposed close to the antenna element while maintaining the strength of the tilt-up mechanism. With this configuration, the present invention is useful to the portable wireless device.

### DESCRIPTION OF REFERENCE SIGNS

11: first housing
13: second housing
15a, 15b: hinge parts
15c: plate part
17: antenna element
19: circuit board
21A, 21B: guide rail
23A, 23B: slider
27A, 27B: groove
29A, 29B: engagement claw
30: cored bar
31: first arm
33: first shaft
35: second shaft
37: support plate
39: horizontal elongate hole
41: third shaft
43: second arm
100 and 200: portable wireless device

1. A portable wireless device comprising:
a first housing comprising therein an antenna element and a circuit board disposed in parallel therewith;
a second housing disposed to overlap with the first housing; and
a tilt holding member comprising a hinge part which rotatably connects one end side of the first housing and one end side of the second housing to each other and which is configured to hold the second housing in a state in which the second housing is tilted with respect to the first housing,
wherein the tilt holding member comprises a cored bar made of a metal material disposed along an arrangement direction of the circuit board and the antenna element, and
wherein the cored bar is divided outside an arrangement range of the circuit board at the antenna element side in the arrangement direction.

2. The portable wireless device according to claim 1, comprising:
a slide rail arranged on a side of the second housing facing the first housing along a direction orthogonal to the arrangement direction; and
a slider arranged at a side of the tilt holding member facing the second housing, and slidably engaged with the slide rail,
wherein the second housing can be tilted with respect to the first housing by sliding the second housing along the slide rail with respect to the first housing and then rotating the hinge part at a termination position of the slider.

3. The portable wireless device according to claim 1,
wherein the second housing comprises a front surface side housing and an intermediate housing disposed between the front surface side housing and the first housing, and
wherein the intermediate housing is connected to the hinge part of the tilt holding member, and is connected to the front surface side housing so as to be slidable along the arrangement direction.

4. The portable wireless device according to claim 1,
wherein the arrangement range of the circuit board is a formation range of a ground pattern.

5. The portable wireless device according to claim 1,
wherein the cored bar is divided at a position outside the arrangement range of the antenna element in the arrangement direction.

6. The portable wireless device according to claim 1,
wherein the cored bar is divided at a position outside the arrangement range of the antenna element in the arrangement direction.

7. The portable wireless device according to claim 1,
wherein the cored bar is divided at a position outside the arrangement range of the antenna element in the arrangement direction.
